(19) United States
(12) Patent Application Publication
(10) Pub. No.: US 2011/0168355 A1
(43) Pub. Date: Jul. 14, 2011

(54) STABILIZING NATURAL CIRCULATION SYSTEMS WITH NANO PARTICLES

(76) Inventors: Arun Kumar Nayak, Mumbai (IN); Manas Ranjan Gartia, Orissa (IN); Krishnan Pallipattu Vijayan, Navi Mumbai (IN)

(21) Appl. No.: 12/672,090

(22) PCT Filed: Aug. 6, 2007
(86) PCT No.: PCT/IN07/00331

§ 371 Date: Mar. 19, 2010

(51) Int. Cl. F28D 15/00; B82Y 30/00

(52) U.S. Cl. 165/104.19; 977/773

(57) ABSTRACT

Natural circulation loop/system adapted to suppress flow instability inherent to fluid medium due to low driving force and non-linearity of the natural circulation process including regenerative feed back between flow rate, driving force and pressure drop by selective metallic oxide nanoparticle base fluid media such as AI₂O3 dispersed in water. Advantageously even small amounts of nanoparticles dispersed in water in the natural circulation systems are found to free the loop from undesirable instability ties and importantly also surprisingly enhance the flow rate thereby facilitating avoiding premature critical heat flux, operation and control problems of such natural circulation based heat recovery. The invention thus provides simple and efficient mode of natural circulation heat recovery with flow stability and enhanced flow rate at reduced cost, favouring wide scale application and use of such system for variety of end uses/applications.

### FIELD OF THE INVENTION

The present invention relates to natural circulation methods/systems for heat removal and in particular to manner of suppression of flow instability inherent to the natural mode of convective heat transfer due to low driving force and non-linearity of the natural circulation process. Importantly, the invention is directed to address the problems encountered in natural circulation methods/systems of heat recovery resulting from flow instability and oscillatory behaviour due to regenerative feed back between flow rate, driving force and pressure drop by way of selective provision of a metal oxide nanoparticle dispersed in water base fluid as a heat recovery media in such natural circulation systems/method. Advantageously, the invention achieves by way of the nanoparticle dispersed base fluid in the natural circulation systems; free the loop from undesirable instabilities and thereby avoid premature critical heat flux, operation and control problems of such natural circulation based heat recovery and also surprisingly enhanced buoyancy induced flow rate of the base fluid across the loop for efficient heat removal. The invention thus would favour simple and efficient natural circulation systems/methods of heat recovery and would favour such mode of cooling by adding stability and enhanced flow rate to its basic advantages such as simplicity in design, elimination of hazards related to pumps; better flow distribution; cost reduction; etc. for a wide scale application and use of such natural circulation based heat recovery for variety of end uses/applications.

### BACKGROUND ART

It is well known that natural circulation systems have numerous applications in engineering fields, viz., solar water heaters, geothermal cooling, nuclear reactor core cooling, gas turbine blade cooling, transformer cooling, etc. It has also been known that the new generation nuclear reactors (Generation III and III⁺) rely on natural circulation for removal of nuclear heat generated due to fission. Natural circulation convective mode of heat removing systems has many fold advantages such as simplicity in design, elimination of hazards related to pumps and other accessories commonly used in forced circulation, lower operating cost and the like. However, one of the major challenges for incorporation of this mode of heat removal is occurrence of flow instabilities. Although instabilities are common to both forced and natural circulation systems, the latter is inherently more unstable than forced circulation systems due to more non-linearity of the natural circulation process and its low driving force. Because of this, any disturbance in the driving force affects the flow which in turn influences the driving force leading to an oscillatory behaviour. Moreover, it is experienced that a regenerative feedback is inherent in such mechanism causing the instabilities in natural circulation due to the strong coupling between the flow and the driving force. Such instabilities are however undesirable to ascertain quantum of desired heat removal, because they degrade the heat removal capability of the system due to occurrence of premature Critical Heat Flux and also impose operational and control problems of the system. In view of this, it has been over the years a requirement in the art to devise new technologies for suppression of such instabilities in natural circulation systems.

There has been no well established process for stabilizing single-phase natural circulation systems, however, recently there are a few scarce reports that the natural circulation flow can be stabilized by adding flow throttling devices such as valves, orifices, etc. in the main flow path. But the extent of resultant improvement in stability depends on the extent of reduction in buoyancy induced flow due to additional flow resistance of throttling devices. As the flow rate gets reduced, the amount of energy removal from such heat generating systems also become limited. In view of such limitations, such methodology for attending to instability aspects in natural circulation systems has not been accepted as a potential solution to the stability problems of natural circulation based heat recovery systems.

There has been therefore a continuing need in the art for the development of natural circulation systems which would overcome the limitations observed in the conventional systems such as low driving/buoyancy force within the range of operating temperature gradient, the flow instability for different power/energy transient, and lower flow rate leading to lower rate of heat removal under steady state flow conditions.

### OBJECTS OF THE INVENTION

It is thus the basic object of the present invention to attend to the aforediscuused problems of flow instability in natural circulation systems resulting basically from non-linearity of the natural circulation process and its low driving force which in turn affected the flow and influenced the driving force leading to an oscillatory behaviour.

Another object of the present invention is directed to address the problem of flow instability in natural circulation systems due to the inherent regenerative feedback in such mechanism causing the instabilities in natural circulation due to the strong coupling between the flow and the driving force which degrade the heat removal capability of the system due to occurrence of premature Critical Heat Flux and also impose operational and control problems of the system.

Yet another object of the present invention is directed to provide the much required effective flow stabilization in natural circulation systems which would avoid the complexities and limitations of the recently attempted flow stabilization in the natural circulation flow by adding flow throttling devices such as valves, orifices, etc. in the main flow path.

Another object of the present invention is directed to provide for flow stability in natural circulation systems which would avoid any limitations of reduction in buoyancy induced flow due to additional flow resistance of throttling devices and the like and thus favour simple and cost-effective energy removal from heat generating systems involving principles of natural circulation.

Another object of the present invention is directed to attend to the problem of instabilities in natural circulation systems and in the process avoid occurrences of premature critical heat flux, related operational and control problems of such systems simply and effectively.

A further object of the present invention is directed to provide for an efficient heat recovery media in natural circulation systems which would significantly improve the stability behavior of such natural circulation systems but also have the potential for augmentation in buoyancy induced flow rate.

A still further object of the present invention is directed to providing for stabilizing natural circulation for heat recovery adapted to be applied to different energy systems thereby facilitating wide scale application and beneficial use of such natural circulation systems.

### SUMMARY OF THE INVENTION

Thus according to the basic aspect of the present invention there is provided a method for stabilizing natural circulation system of heat removal applications comprising:
providing metallic oxide nanoparticles dispersed in water as a base fluid media;
introducing the thus obtained nanoparticles dispersed in water in natural circulation loop of said heat removal system to achieve stabilized natural circulation of the base fluid for said heat removal purposes.

In the above method of the invention an aqueous solution of dispersed nanoparticles in water is provided as the base fluid media by adding different concentrations of said metallic oxide nano particles in water.

Advantageously, according to an aspect of the invention the said metallic oxide nanoparticles are selectively used in dispersed state in water to free the heat recovery loop from undesired instabilities and thereby avoid premature critical heat flux, operation and control problems of such natural circulation based heat recovery systems.

According to another aspect of the invention in the method of the invention the said metallic oxide nanoparticles are selectively used to enhance the buoyancy induced flow rate of the base fluid across the loop for efficient heat removal.

According to yet another aspect of the invention in the above method of the invention the said metallic oxide nanoparticles used are selected to free the natural circulation flow of base fluid from instabilities resulting from regenerative feedback between the flow rate, pressure drop and driving force.

Importantly, the said nanoparticles used are selected to be metallic oxide nanoparticles, such as Al₂O₃.

In accordance with yet another preferred aspect of the invention in the above method for effective dispersion of the said nanoparticles in water prior to introducing the same in the natural circulation loop the same is subjected to vibration preferably Ultrasonic vibration.

The nanoparticles are provided in selective amounts such as to facilitate the suppression of flow instabilities and/or achieve increase in the flow rates.

In accordance with an aspect of the invention the amount of nano particles range of about 0.3% to 2% by wt. of the water has revealed that there is progressive increase in favourable stability characteristics and flow enhancement .

In accordance with another aspect of the present invention there is provided a system of natural circulation loop based heat recovery comprising:
a loop with defined flow cross-section area for the flow of the base fluid;
a heat source operatively associated with the loop along a region of the said loop;
a cooling region for cooling the heated base fluid flowing through the loop;
said heat source and cooling region selectively disposed in the loop to facilitate the natural circulation based on temperature gradient;
said base fluid comprising metallic oxide nanoparticles dispersed in water to facilitate the suppression of flow instabilities in the loop and/or increasing the flow rate within the loop for effective natural circulation.

According to another preferred aspect of the invention the system of natural circulation loop comprises:
a substantially rectangular natural circulation loop with defined circular flow cross-section area for the flow of a base fluid;
a heat source operatively associated with the loop along the bottom horizontal leg of the said loop;
a cooling region for cooling the heated base fluid flowing through the loop comprising a heat exchanger means at the top;
said heat source and cooling region selectively disposed in the loop to facilitate the natural circulation based on temperature gradient;
an expansion tank at the topmost elevation adapted to accommodate the volumetric expansion of the base fluid;
said base fluid comprising metallic oxide nanoparticles dispersed in water to facilitate the suppression of flow instabilities in the loop and increasing the flow rate within the loop for effective natural circulation.

Advantageously, in accordance with a preferred aspect of the system of the invention the loop is insulated to avoid heat loss at ambient temperatures.

In accordance with yet another aspect of the present invention there is provided a heat removal media as a means for stabilizing natural circulation in heat recovery methods/systems comprising base fluid having nano particles dispersed in water.

The present invention, its objectives and advantages are described hereunder in greater detail with reference to the following non-limiting illustrative examples and accompanying figures.

### BRIEF DESCRIPTION OF THE FIGURES

FIG. 1: is a schematic illustration of an arrangement of the natural circulation system for heat recovery wherein the selective heat recovery media comprise metal oxide nanoparticle dispersed in water in accordance with the present invention;

FIG. 2: is the graphical representation of the natural circulation stability behaviour in the loop with water alone during a Power transient for an initial power of 150 W and step rise of 150 W;

FIG. 3: is the graphical representation of a typical unstable natural circulation behaviour in the loop with water alone during a power rise process for an initial power of 300 W and onwards step rise of 100 W; and then a power setback from 600 W to 400 W in steps of 100 W.

FIG. 4: is the graphical representation of the natural circulation behaviour in the loop/system, effects of addition of nanoparticles during a Power transient;

FIG. 5: is the graphical representation of natural circulation behaviour in the loop, effects of addition of nanoparticles during a power rise and setback process ;

FIG. 6(a): is the graphical representation of the comparison of steady state flow rates with and without dispersion of nanoparticles in water in the loop.

FIG. 6(b): is the illustration of time averaged steady state flow rates with and without dispersion of nanoparticles in water at different power.

### DETAILED DESCRIPTION WITH REFERENCE TO THE ACCOMPANYING FIGURES

The present invention as discussed above is directed to avoiding the instability and flow complexities in natural circulation systems and provide for an efficient manner of heat recovery in natural circulation systems which would be substantially free of unwanted disturbances in the driving force which in turn lead to oscillatory behaviour. The manner of achieving such purpose of avoiding instabilities in the flow and further enhance the flow rate in natural circulation system following the method and system of the invention involving the heat recovery media comprising metal oxide nano particles dispersed in water vis-a-vis the conventional only water media for heat recovery in natural circulation systems is detailed hereunder:

### EXAMPLE I

### Preparation of the Nano Particle Dispersed in Water Heat Recovery Media of the Present Invention for Natural Circulation Systems

The aqueous solutions of dispersed nanoparticles in water were prepared separately by adding the different concentrations (by weight) of Al₂O₃ (Alumina) nano powder of average particle size 40-80 nanometer and 99.7% purity to water. To prevent the particles from agglomerating and settling, the suspension was sonicated in an ultrasonic bath. The dispersion of the particle was first done by mixing the required volume of powder in the chemical measuring flask with distilled water and then using Ultrasonic vibration to disperse it. After making a proper mixture, the respective flasks having nanoparticles of desired concentrations, were kept again under ultrasonic vibration for about 4 hours, which was a sufficient time to ensure stable particle dispersion in water without agglomeration.

### An Embodiment of Closed Loop Natural Circulation System for Use with the Heat Recovery Media of the Invention

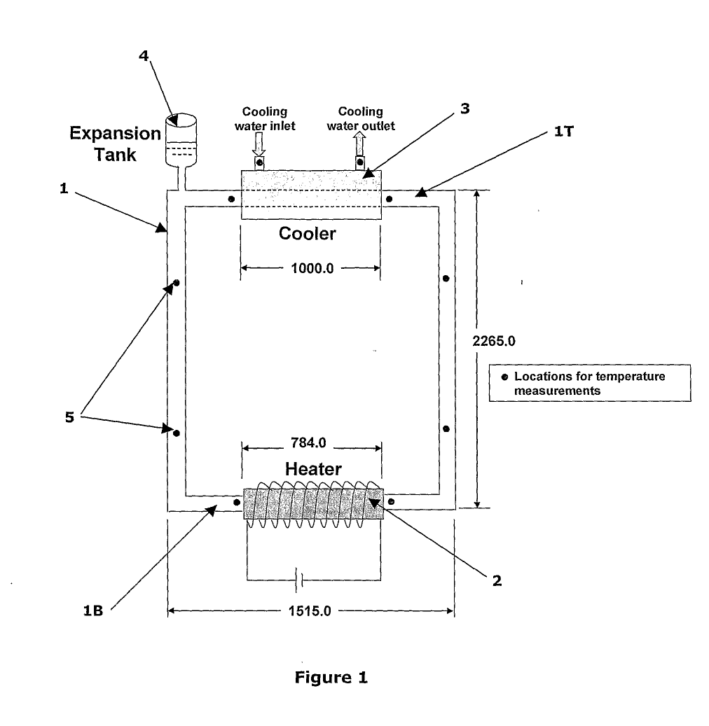

In order to facilitate the study of the stability and flow characteristics in a closed loop natural circulation environment of the nanoparticle dispersed in water as the base fluid media of the invention vis-à-vis the only water as base fluid as per the conventional art, a natural circulation loop was provided as per the accompanying FIG. 1.

As shown in FIG. 1, the natural circulation loop used comprised a rectangular natural circulation loop (1) with circular flow cross-section area. Such a natural circulation loop is relevant to nuclear and solar power generating systems. The loop (1) had a heat source (2) in the form of a heater heating through electric wire which was wound uniformly on the outer surface of the tubular portion in the bottom horizontal leg (1B). The loop (1) is provided with cooler arrangement (3) at the top (1T) through a tube-in-tube type heat exchanger with tap water flowing through the annulus. An expansion tank (4) is shown provided at the topmost elevation to accommodate the volumetric expansion of the fluid. It also ensures that the loop remains full of water.

In order to facilitate the study of stability and flow rate based on the base fluid media as per Example 1 above and the only water media as per the conventional art, thermocouples means (5) were installed at different locations in the loop to measure the instantaneous local temperature. The flow rate was measured using a pressure transducer installed in the horizontal leg of the loop. Furthermore the instruments were connected to a data acquisition system which could scan all the channels in less than one second. The secondary side cooling water flow rate was measured with the help of a rotameter. The loop was kept insulated to minimize the heat losses to the ambient.

Study of the stability and flow behaviour was conducted at different powers which are typical to that of a power raising and setback phenomena in any power generating system. The important flow parameters which were recorded are: the pressure drop across the heater, temperatures at 13 different locations in the loop as shown in FIG. 1 and the heater power.

As is well known, in any natural circulation mode of transporting heat in fluid media, the flow is established when the driving buoyancy force induced by the density difference between the hot and cold legs exceeded the resistive frictional forces in the loop. When the fluid in the loop as per FIG. 1 is heated, convection current is setup in the loop. The hot fluid rises up in the hot leg and gets cooled when it passes through the cooler. This resulted in low temperature in the cold leg. Thus, the driving force is set-in due to the density difference of the fluid between the hot and cold legs.

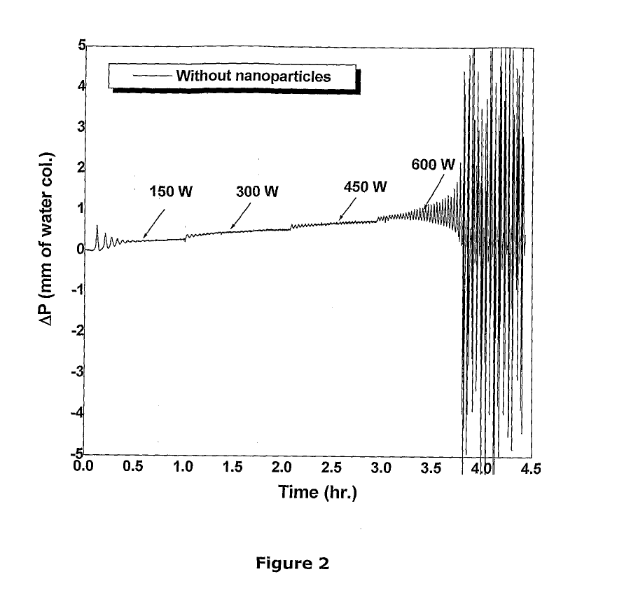

The manner of implementation of the present invention directed to stabilizing flow instabilities on a time scale for different wt % concentration of nano-particles of 1% and 2% dispersed in water as obtained under Example I above as against water alone as the circulation medium for different energy transient in steps including power set-back in steps, was studied and the results obtained are discussed hereunder in the following Examples II to V and in relation to accompanying FIGS. 2 to 6(a) & (b):

### EXAMPLE II

Under this example the natural circulation behaviour in the loop with water alone as per the conventional base fluid was studied during a power transient for an initial power of 150 W and step rise of 150 W. For the purpose the system as per accompanying FIG. 1 was used and water was introduced into the system as the heat recovery media.

The results obtained are reflected in accompanying FIG. 2. Reference is now invited to accompanying FIG. 2 which is the illustration of the transient natural circulation behaviour along the loop of FIG. 1, during a power raising process from an initial power of 150 W in steps of 150 W. As clearly apparent from FIG. 2, the flow was found to be stable until the power is raised to 450 W. However, in the next step of power rise at 600 W, flow instabilities appeared in the loop characterized by large amplitude flow oscillation with flow reversals.

### EXAMPLE III

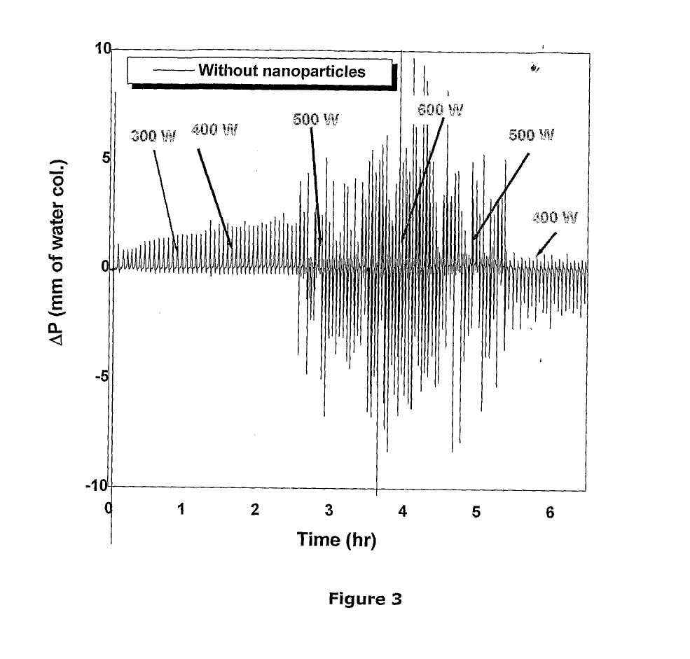

Under this example the natural circulation behaviour in the loop with water alone during a power transient for an initial power of 300 W and step rise of 100 W Was studied. The results are represented in accompanying FIG. 3.

Reference is invited to accompanying FIG. 3, which illustrates that under this study instabilities were observed even at lower heat input at 300 W. The amplitude of oscillations kept on increasing with rise in power. At 600 W, a power setback behaviour study was conducted to illustrate the instability behaviour during a setback process. The power was reduced to 400 W from 600 W in steps of 100 W. The flow instabilities were found to continue although their characteristics were different for the corresponding powers during rising steps.

### EXAMPLE IV

Under this example the natural circulation behaviour in the loop with water alone as per the conventional base fluid alongwith the behaviour with nanoparticles dispersed in water (1%) and (2%) were studied during a power transient as followed under Examples II and III above.

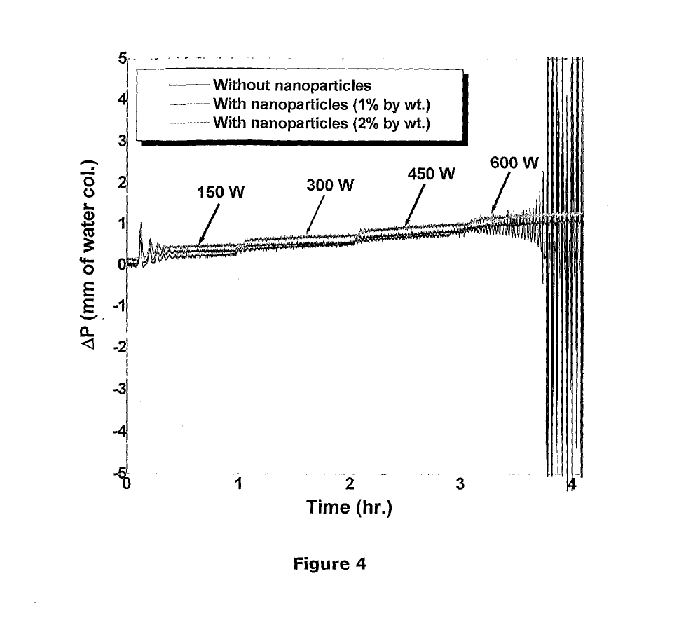

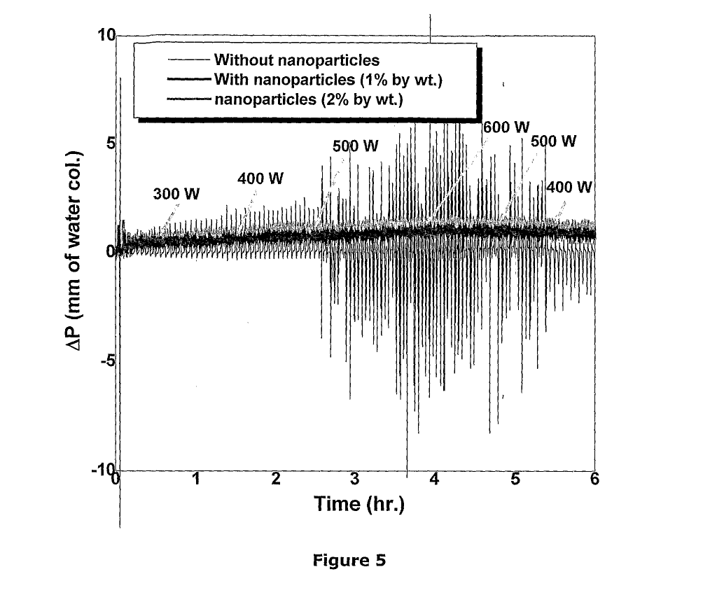

The nature of the effects of nanoparticles dispersed in water on the stability behaviour of the loop circulation are shown in FIGS. 4 and 5 respectively, As clearly apparent from the comparative illustrations in FIGS. 4 and 5 the provision of Al₂O₃ Nano powder dispersed in water as the base fluid heat recovery media provided for clear improvement in flow stability since the instabilities arising from use of water alone as a fluid media are suppressed . Importantly , likewise Al₂O₃ any metallic oxide nano powder should have similar effects on the natural circulation behaviour.

### EXAMPLE V

Under this example the effects of nano powder dispersed in water fluid media in natural circulation was further studied and the results are discussed hereunder:

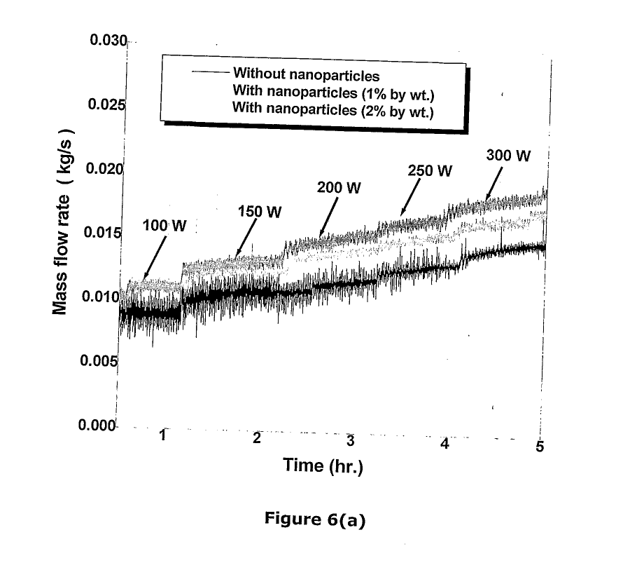

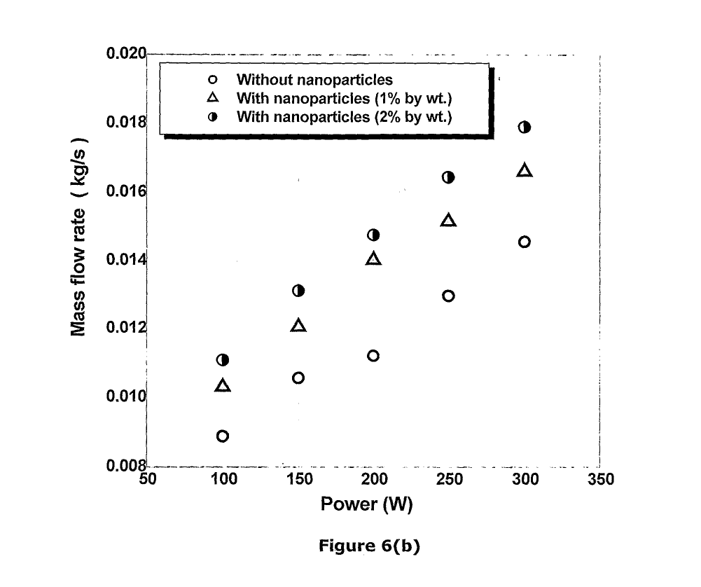

Accompanying FIGS. 6(a) to 6(b) illustrates clearly that the flow is not only stabilized with nanoparticles with water in the loop, but also the steady state flow rates are found to be higher with nanoparticles as compared to that with water alone. The flow rates have been estimated from the measured pressure drop in the pressure transducer.

Thus the above results clearly and sufficiently reveal that the flow instabilities in natural circulation systems are surprisingly suppressed even with a small concentration of nano powder. Also, the stable flow rate was found to rise with water having dispersed nanoparticles. The other significant advantage with nanoparticles dispersed fluids (water) is that the flow rate is enhanced unlike that with throttling devices, which add to the surprising finding of the flow behaviour in natural circulation for heat, removal in accordance with the present invention.

It is thus possible by way of this invention to provide for the much required solution to the hereto before unattended problems of flow instability in natural circulation systems/loop resulting basically from non-linearity of the natural circulation process and its low driving force which in turn affected the flow and influenced the driving force leading to an oscillatory behaviour. Importantly, the invention for the first time favours achieves the desired suppression of flow instabilities in natural circulation systems with metal oxide nano powder and also surprisingly enhanced natural circulation flow rate with the heat recovery media involving the nano particles dispersed in water. Thus the present invention would favour providing for stabilizing natural circulation for heat recovery adapted to be applied to different energy systems thereby facilitating wide scale application and beneficial use of such natural circulation systems.

What is claimed is:

1-14. (canceled)

15. A method for suppression of flow instabilities and enhancement of buoyancy induced flow rate in natural circulation systems of heat removal applications comprising:
providing metallic oxide nano particles in the range of 0.3 to 2 wt % dispersed in water as a base fluid media, which forms a suspension;
introducing the thus obtained suspension of nano particles dispersed in water in natural circulation loops of said heat removal system.

16. A method according to claim 15 wherein said suspension is provided by adding different concentrations of said metallic oxide nano particles in water.

17.

[symbol]

18. A method according to claim 15, wherein said metallic oxide nano particles are selectively used to enhance the buoyancy induced flow rate of the base fluid across the loop for efficient heat removal.

19. A method according to claim 15, wherein said metallic oxide nano particles are selected to free the natural circulation flow of base fluid from instabilities resulting from regenerative feedback between the flow rate, pressure drop and driving force.

20. A method according to claim 15, wherein said metallic oxide nano particles are selected from metallic oxides such as Al₂O₃.

21. A method according to claim 15 wherein for effective dispersion of the said nanoparticles in water prior to introducing the same in the natural circulation loop, the same is subjected to ultrasonic vibration free of any additives.

22. A method according to claim 15 wherein the nano particles are provided in selective amounts such as to facilitate the suppression of flow instabilities and achieve increase in the natural circulation flow rates.

23. A system of natural circulation loop based heat recovery comprising :
a loop with defined flow cross-section area for the flow of the base fluid;
a heat source operatively associated with the loop along a region of the said loop;
a cooling region for cooling the heated base fluid flowing through the loop ;
said heat source and cooling region selectively disposed in the loop to facilitate the natural circulation based on temperature gradient;
said base fluid comprising metallic oxide nano particles selectively in the range of 0.3 to 2 wt % dispersed in water to facilitate the suppression of flow instabilities in the loop and increase in the natural circulation flow rate in the loop for effective natural circulation.

24. A system of natural circulation loop according to claim 23 comprising :
a rectangular natural circulation loop with defined circular flow cross-section area for the flow of a base fluid;
a heat source operatively associated with the loop along the bottom horizontal leg of the said loop;
a cooling region for cooling the heated base fluid flowing through the loop comprising a heat exchanger means at the top;
said heat source and cooling region selectively disposed in the loop to facilitate the natural circulation based on temperature gradient;
an expansion tank at the topmost elevation adapted to accommodate the volumetric expansion of the base fluid;
said base fluid comprising metallic oxide nano particles selectively in the range of 0.3 to 2 wt % dispersed in water to facilitate the suppression of flow instabilities in the loop and increasing the natural circulation flow rate in the loop for effective natural circulation.

25. A system of natural circulation loop according to claim 23 wherein the loop is insulated to avoid heat loss at ambient temperatures.

26. A heat removal media comprising a base fluid having nano particles selectively in the range of 0.3 to 2 wt % dispersed in water.
